(19) United States
(12) Patent Application Publication
(10) Pub. No.: US 2006/0026043 A1
(43) Pub. Date: Feb. 2, 2006

(54) Medical records system and method

(76) Inventors: John K. Schneider, Snyder, NY (US); Leonard Pratt, Lockport, NY (US); Michael Amalfi, Pittsford, NY (US); Jack C. Kitchens, Tonawanda, NY (US)

Correspondence Address: HODGSON RUSS LLP, ONE M & T PLAZA, SUITE 2000, BUFFALO, NY, 14203-2391, US

(21) Appl. No.: 11/192,947

(22) Filed: Jul. 29, 2005

Related U.S. Application Data
(60) Provisional application No. 60/592,594, filed on Jul. 30, 2004.
(60) Provisional application No. 60/598,655, filed on Aug. 4, 2004.

(51) Int. Cl. G06F 19/00

(52) U.S. Cl. 705/3; 382/115; 707/9

(57) ABSTRACT

Medical information systems and methods are disclosed. A database of pointers may be used to identify the location of medical information and a biometric may be required to obtain those pointers.

### CROSS-REFERENCE TO RELATED APPLICATION

This application claims the benefit of priority to U.S. provisional patent application Ser. No. 60/592,594, filed on Jul. 30, 2004, and U.S. provisional patent application Ser. No. 60/598,655 filed on Aug. 4, 2004.

### FIELD OF THE INVENTION

The present invention relates to medical records and the systems and methods that assist with retrieving medical record information.

### BACKGROUND OF THE INVENTION

In the prior art there are electronic systems for maintaining and delivering medical information. These systems typically require a user identification number and password to obtain information from an entity's medical information database. Such systems will allow access to the medical information to anyone possessing a valid identification number and password, even when the identification number and password are possessed by someone who is not authorized. Further, such systems do not assist with accessing medical records for the same patient from two different entities. As such, the existing systems leave much to be desired.

### SUMMARY OF THE INVENTION

The present invention includes systems and methods related to medical records. For example, a system in keeping with the invention may include a database having database information. The database information may include pointers to patient medical records and include biometric records. Each biometric record may be correlated with at least one pointer. A computer may be in communication with the database, and the computer may be programmed to (a) accept a biometric specimen, (b) search the database for a matching biometric record, and (c) upon locating a matching biometric record, provide the correlated pointer.

In a method of accessing medical records, (a) a database may be provided, and the database may have database information that includes pointers to patient medical records and may include biometric records. Each biometric record may be correlated with at least one pointer. A biometric specimen may be provided, and the database may be searched to locate biometric records that match the biometric specimen. A matching biometric record may be located and the pointer that is correlated with the located biometric record may be provided. The pointer may be used to identify and retrieve a patient medical record.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a schematic of a system according to the invention;

FIG. 2, which is a schematic of another system according to the invention;

FIG. 3, which is a flow chart depicting a method according to the invention; and

FIGS. 4a and 4b, which together are a flow chart depicting another method according to the invention.

### FURTHER DESCRIPTION OF THE INVENTION

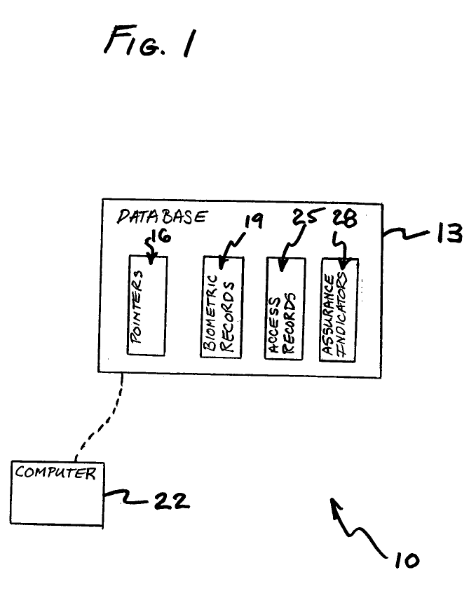

FIG. 1 depicts an example of a medical records system 10 having features according to the invention. In that system 10 there is a database 13 having database information. The database information may include pointers 16 to patient medical records. Pointers 16 may be computer readable instructions used to locate a medical record in a database.

The database information may include biometric records 19. A biometric record 19 may be information readable by a computer that describes a biometric, such as a fingerprint or iris scan, of a person that is authorized to use the medical records system 10 or a patient having medical records. Each biometric record 19 may be correlated with at least one pointer 16.

The computer 22 may also be programmed to determine whether patient authorization is needed before information from the patient medical record is provided. For example, under U.S. law, patient authorization is required in order to release most information in a medical record, including information that may not be medical in nature, such as the patient's name, phone number or date of birth. Determining whether patient authorization is needed may be accomplished by analyzing the data stream coming from the user of the medical information system 10, or by analyzing the data stream that is about to be provided to the user of the medical information system 10. If the data stream includes key words that are on a predetermined list, then it may be assumed by the computer that authorization is needed. If patient authorization is needed, then the computer 22 may prompt a user of the medical records system to provide authorization. Authorization may be in the form of a biometric specimen of the user, or a biometric specimen of the patient.

A computer 22 may be in communication with the database 13. Communication between the computer 22 and the database 13 may be provide via by a telephone link, high speed cable link, a network of computers such as the Internet or via satellite. The computer 22 may be programmed to (a) accept a biometric specimen, (b) search the database 13 for a matching biometric record 19, and (c) upon locating a matching biometric record 19, provide the correlated pointer 16. The biometric specimen may be a fingerprint or iris scan taken from an individual at the time access to a medical record is desired. The computer 22 may be programmed to use the pointer 16 to retrieve the patient medical record identified by the correlated pointer 16.

The computer 22 may be programmed to accept an identification code, such as a personal identification number such as a birthday, and use that code to identify biometric records 19 that may match the biometric specimen. The identification code may also describe a feature of the person using the system, for example, whether the person's left thumb fingerprint is a whirl pattern, arch pattern or some other pattern. In this manner, the search for a biometric record 19 that matches the biometric specimen may be accomplished faster.

The database information may include an access record 25 that is correlated with one or more of the patient medical records. The access record 25 may include information pertaining to actions taken with respect to a patient medical record. For example, the access record 25 may state that Dr. Jones accessed the medical record on Jul. 1, 2004 and added an x-ray to the medical record. In this manner, it may be possible to determine who modified the medical record and when that modification was made.

The database 13 may include an assurance indicator record 28 that is associated with one or more of the pointers 16. Each assurance indicator in the assurance indicator record 28 may indicate the certainty with which a particular pointer 16 identifies a medical record that is for an individual identified by the biometric record 19. For example, the medical records may include a biometric sample, and when the biometric record 19 matches the biometric sample, then the assurance indicator 28 may indicate a high degree of certainty.

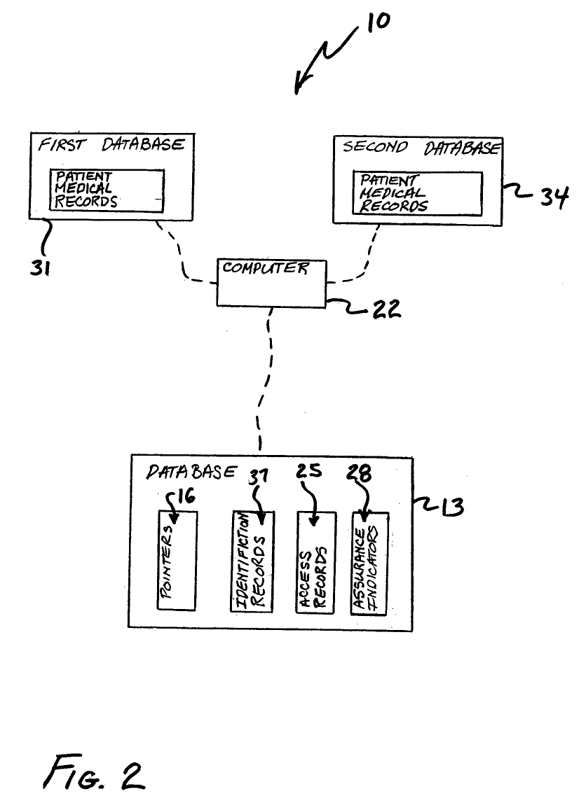

FIG. 2 depicts a more complex embodiment of the invention. In FIG. 2 there is shown a medical information system 10 having three databases. Features similar to those shown in FIG. 1 have the same feature number as that used in FIG. 1. A first database 31 has stored therein patient medical records of a first entity, such as a hospital. A second database 34 has stored therein patient medical records of a second entity, such as a medical practice of a physician. A third database 13 has stored therein pointers 16 to medical records, wherein each pointer 16 may be correlated with an identification record 37. An identification record 37 may include information readable by a computer that must be matched before access to information in the third data base 13 is permitted. Pointers 16 having the same identification record 37 may be correlated with each other to form a correlated record.

A computer 22 may be in communication with the databases 13, 31, 34 and programmed to receive a personal identifier, such as a biometric specimen of the patient or a physician. The computer 22 may also be programmed to compare the personal identifier to the identification record 37, and if the result of the comparison is that there is a match between the personal identifier and the identification record 37, then the computer 22 would request the correlated record from the third database 13 for the received personal identifier. The computer 22 may also be programmed to provide, upon receiving the correlated record, a request to the first database 31 for medical records located at the first pointer 16 and a request to the second database 34 for medical records located at the second pointer 16.

Similar to that described above, the computer 22 may also be programmed to accept an identification code, and use that code to locate identification records 37 that may match the biometric specimen. By doing so, the time required to match a biometric specimen to an identification record 37 may be reduced.

The third database 13 may include access records 25, similar to that described above. Further, the third database 13 may include assurance indicators 28 that are associated with pointers 16 and indicate the certainty with which a particular pointer 16 identifies a medical record that is for an individual identified by the personal identifier. For example, the medical records may include a biometric sample, and if the identification record 37 is a biometric that matches the biometric sample, then the assurance indicator 28 may indicate a high degree of certainty.

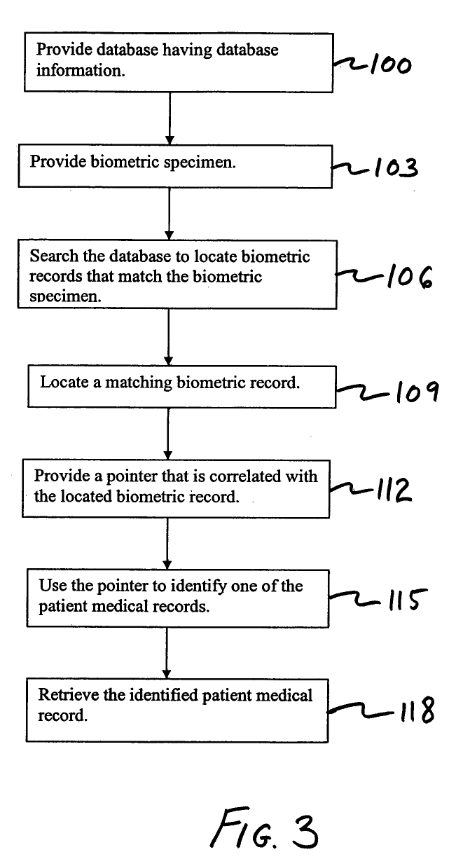

FIG. 3 depicts a method according to the invention. The method shown in FIG. 3 provides 100 a database having database information. The database information may include pointers to patient medical records. The database information may include biometric records. Each biometric record may be correlated with at least one pointer. A biometric specimen, such as a fingerprint or iris scan, may be provided 103, for example from an ultrasound fingerprint imaging device. The database may be searched 106 to locate biometric records that match the biometric specimen, and a biometric record matching the biometric specimen may be located 109. The pointers that are correlated with that biometric record may be provided 112, and used 115 to identify one of the patient medical records. The identified patient medical record may be retrieved 118 and provided for use, for example to a physician or insurance company.

In some instances, the method may also include determining whether patient authorization is needed before information from the patient medical record is provided. Determining whether authorization is needed may be accomplished as outline above. If patient authorization is needed, then the user of the medical records system may be prompted to provide authorization. Authorization may be in the form of a biometric specimen of the user, or a biometric specimen of the patient.

A method according to the invention may include providing an identification code, which may be used to identify biometric records associated with the identification code. In this manner, the number of biometric records that must be searched may be reduced.

A method according to the invention may include recording actions taken on a patient medical record, and correlating those recorded actions with the identified patient medical record. In this manner, it may be possible to determine when and by whom a medical record was accessed, and/or what changes were made to the accessed medical record.

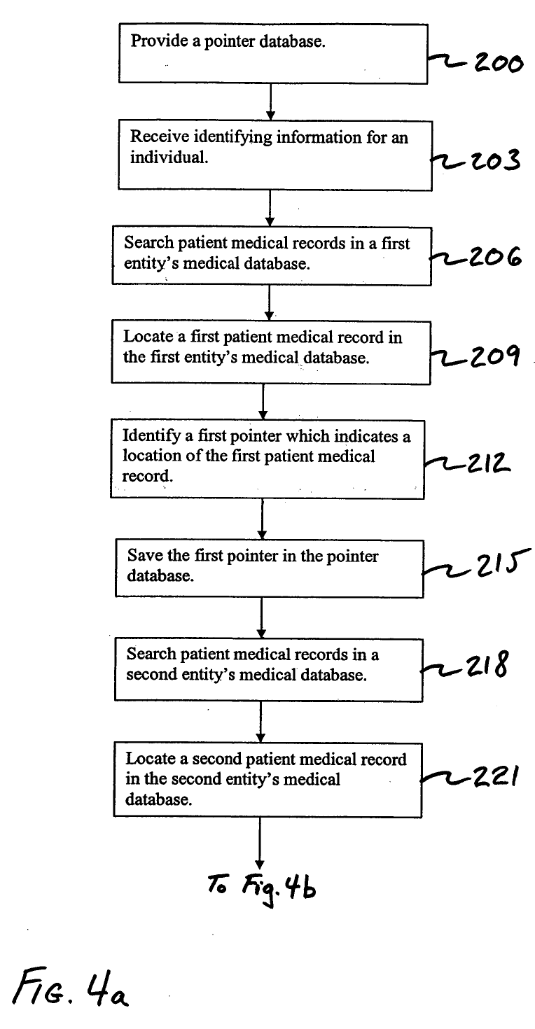

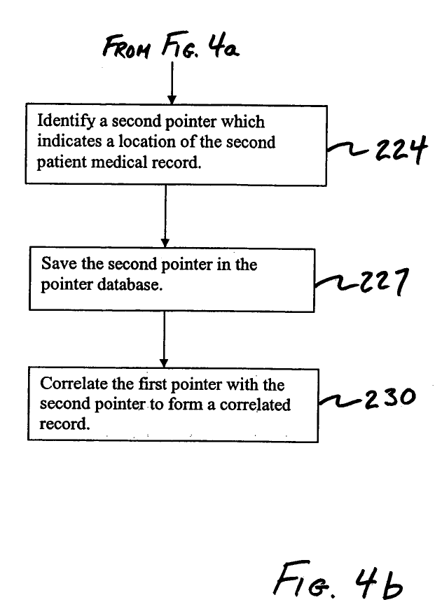

FIGS. 4a and 4b depict another method according to the invention. In that method, a database is provided 200, and identifying information for an individual is received 203. The patient medical records of a first entity's medical database may be searched 206. A first patient medical record in the first entity's medical database may be located 209, the first patient medical record having the identifying information. A first pointer, which indicates a location of the first patient medical record, may be identified 212 and saved 215 in the pointer database.

Then the process may be repeated for a second entity's medical database. In doing so, the patient medical records in the second entity's medical database may be searched 218, and a second patient medical record, which has the identifying information, may be located 221 in the second entity's medical database. A second pointer, which indicates a location of the second patient medical record, may be identified 224. The second pointer may be saved 227 in the pointer database, and correlated 230 with the first pointer to form a correlated record.

A biometric record may be correlated with the correlated record. A biometric indicator may be correlated with the correlated record in order to identify pointers that indicate a location of a patient medical record that has a biometric sample that matches the biometric record. In this manner, the biometric indicator may serve as an assurance indicator, which was described above.

Further, an access record, similar to that described above, may be created and used, in a manner similar to that described above.

It will be recognized that systems and methods according to the invention may assist medical service providers in avoiding tests and procedures that have been done by another entity. By allowing a medical service provider to access the medical records of another entity, the medical service provider not only avoids providing duplicate services, but may use the medical records of the other entity to provide treatment to a patient sooner than might be possible using existing systems and methods. Further, it may be possible to review the medical records in various databases that attributed to the same person in an effort to determine whether some of the medical records belong to another person. Further, medical records may be updated and modified to reflect the most current information and provide that current information to a number of medical service providers.

In addition, systems and methods according to the invention may be used with existing medical records databases. By retrofitting an existing medical records database, the owner of that database may be able to achieve the advantages of the invention, but avoid at least some of the costs that might be incurred by centralizing medical records and requiring that all medical records conform to a particular format.

Finally, advantages of the invention may include providing secure access to medical records without requiring the use of man-made personalized tokens, such as swipe cards or smart cards, while preventing access to medical information by individuals that possess codes, numbers or cards without authorization to possess those codes, numbers or cards.

U.S. provisional patent application Ser. No. 60/592,594, filed on Jul. 30, 2004, and U.S. provisional patent application Ser. No. 60/598,655 filed on Aug. 4, 2004 include information about systems and methods according to the invention. For purposes of further describing the invention and how the invention might be embodied, these provisional patent applications are incorporated herein by this reference.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A medical records system, comprising:
a database having database information, the database information including pointers to patient medical records and including biometric records, each biometric record being correlated with at least one pointer;
a computer in communication with the database, the computer being programmed to (a) accept a biometric specimen, (b) search the database for a matching biometric record, and (c) upon locating a matching biometric record, provide the correlated pointer.

2. The medical records system of claim 1, wherein the computer is also programmed to use the pointer to retrieve the patient medical record identified by the correlated pointer.

3. The medical records system of claim 2, wherein the computer is further programmed to determine whether patient authorization is needed before the patient medical record is provided, and if patient authorization is needed, then prompting a user of the medical records system to provide authorization.

4. The medical records system of claim 3, wherein the authorization is a biometric specimen.

5. The medical records system of claim 1, wherein the computer is also programmed to accept an identification code, and use that code to identify biometric records that may match the biometric specimen.

6. The medical records system of claim 1, wherein the database information includes an access record that is correlated with one of the patient medical records, the access record including information pertaining to an access of the patient medical record.

7. The medical records system of claim 6, wherein the access record identifies a date on which the one of the patient medical records was accessed.

8. The medical records system of claim 6, wherein the access record identifies actions taken with respect to the one of the patient medical records.

9. The medical records system of claim 1, wherein an assurance indicator is associated with the pointer, the assurance indicator indicating the certainty with which the pointer identifies a medical record that is for an individual identified by the biometric record.

10. The medical records system of claim 9, wherein the assurance indicator indicates a high degree of certainty when the biometric record matches a biometric sample that is related to the medical record identified by the correlated pointer.

11. A method of accessing medical records, comprising:
providing a database having database information, the database information including pointers to patient medical records and including biometric records, each biometric record being correlated with at least one pointer;
providing a biometric specimen;
searching the database to locate biometric records that match the biometric specimen;
locating a matching biometric record;
providing the pointer that is correlated with the located biometric record; and
using the pointer to identify one of the patient medical records; and
retrieving the identified patient medical record.

12. The method of claim 11, further comprising, determining whether patient authorization is needed before the patient medical record is provided, and if patient authorization is needed, then prompting a user of the medical records system to provide authorization.

13. The method of claim 12, wherein the authorization is a biometric specimen.

14. The method of claim 11, further comprising:
providing an identification code;
identifying biometric records associated with the identification code in order to reduce the number of biometric records that must be searched.

15. The method of claim 11, further comprising:
recording actions taken on the identified patient medical record; and
correlating the recorded actions with the identified patient medical record.

16. A medical information system, comprising:
a first database having stored therein patient medical records of a first entity;
a second database having stored therein patient medical records of a second entity;
a third database having stored therein pointers to medical records, wherein each pointer is correlated with an identification record, and pointers having the same identification record are correlated with each other to form a correlated record;
a computer in communication with the databases and programmed to (a) receive a personal identifier, (b) request the correlated record from the third database for the received personal identifier, (c) compare the identification record to the personal identifier, and if the comparison indicates a match, then receive from the third database a first pointer to a medical record in the first database, and a second pointer to a second medical record in the second database, and (d) provide a request to the first database for medical records located at the first pointer and a request to the second database for medical records located at the second pointer.

17. The medical records system of claim 16, wherein the computer is further programmed to determine whether patient authorization is needed before one or both of the patient medical records are provided, and if patient authorization is needed, then prompting a user of the medical records system to provide authorization.

18. The medical records system of claim 17, wherein the authorization is a biometric specimen.

19. The medical information system of claim 16, wherein the identification record includes a biometric record, and wherein the computer is programmed to provide the at least one of the correlated records upon receiving a biometric specimen that matches the biometric record.

20. The medical information system of claim 19, wherein the computer is also programmed to accept an identification code, and use that code to identify biometric records that may match the biometric specimen.

21. The medical records system of claim 16, wherein the third database includes an access record that is correlated with one of the patient medical records, the access record including information pertaining to an access of the one of the patient medical records.

22. The medical records system of claim 21, wherein the access record identifies a date on which the one of the patient medical records was accessed.

23. The medical records system of claim 21, wherein the access record identifies actions taken with respect to the one of the patient medical records.

24. The medical records system of claim 16, wherein an assurance indicator is associated with the first pointer, the assurance indicator indicating the certainty with which the first pointer identifies a medical record that is for an individual identified by the identification record.

25. The medical records system of claim 24, wherein the identification record includes a biometric record and the assurance indicator indicates a high degree of certainty when the biometric record matches a biometric sample that is related to the first medical record.

26. A method of correlating medical information, comprising:
providing a pointer database;
receiving identifying information for an individual;
searching patient medical records in a first entity's medical database;
locating a first patient medical record in the first entity's medical database, the first patient medical record having the identifying information;
identifying a first pointer which indicates a location of the first patient medical record;
saving the first pointer in the pointer database;
searching patient medical records in a second entity's medical database;
locating a second patient medical record in the second entity's medical database, the second patient medical record having the identifying information;
identifying a second pointer which indicates a location of the second patient medical record; and
saving the second pointer in the pointer database;
correlating the first pointer with the second pointer to form a correlated record.

27. The method of claim 26, further comprising:
correlating a biometric record with the correlated record;
providing a biometric indicator, the biometric indicator, which identifies at least one pointer that indicates a location of a patient medical record that has a biometric sample that matches the biometric record.

28. The method of claim 26, further comprising providing an assurance indicator for the first pointer, the assurance indicator indicating the certainty with which the first pointer identifies a medical record that is for the individual.

29. The method of claim 28, further comprising:
correlating a biometric record with the correlated record; and
wherein the assurance indicator indicates a high degree of certainty when the biometric record matches a biometric sample that is related to the first medical record.

30. The method of claim 26, further comprising:
creating an access record, the access record including information about activity within the first medical record; and
correlating the access record with the first pointer.
